(19) United States
(12) Patent Application Publication
(10) Pub. No.: US 2021/0368595 A1
(43) Pub. Date: Nov. 25, 2021

(54) Control of Regulated Current Source in Dimmable LED Lamps

(71) Applicant: Shafrir Romano, Rishon Lezion (IL)

(72) Inventor: Shafrir Romano, Rishon Lezion (IL)

(21) Appl. No.: 16/879,864

(22) Filed: May 21, 2020

(51) Int. Cl. H05B 45/10; H05B 45/345; H05B 45/325

(52) U.S. Cl. CPC H05B 45/10; H05B 45/325; H05B 45/345

(57) ABSTRACT

Disclosed is a control system for a dimmable LED lamp. The LED lamp comprises a regulated constant current power supply (PS). A dimming control signal D between Dmax and Dmin results in PS output current (Iout) between Imax and Imin respectively, Imin>0, for powering a LED array. For achieving LED current I_{L} lower than Imin, the control system increases D so as to determine Iout as I_{L}+Imin and causes a bleeder unit to load the PS by Imin.

### FIELD OF THE INVENTION

The present invention relates generally to lighting systems, and more particularly to methods and systems for controlling regulated constant current based LED drivers.

### BACKGROUND OF THE INVENTION

Light Emitting Diodes (LED)s have become a prevailing technology in the industry of lighting. Alongside the market transition to LED lighting, dimming techniques of LED arrays have developed in the art. However, in some dimming techniques, the light intensity is limited by some minimum level. A possible means for mitigating this problem is using bleeder circuitry so as to maintain some current consumption when the current consumed by the LED array decreases below a certain value.

As an example, U.S. Pat. No. 9,307,593 discloses a light-emitting diode (LED) lamp, comprising: an LED string including one or more LEDs; a rectifier circuit configured to receive an AC input voltage and to generate a rectified voltage corresponding to the AC input voltage, the rectified voltage is a phase-cut AC input voltage indicating a dimming level; a bleeder circuit coupled to the rectifier circuit and configured to turn on to provide a bleeder current at a first current level responsive to the AC input voltage less than a first threshold voltage and to reduce the bleeder current to a second current level responsive to the AC input voltage exceeding a second threshold voltage; and an LED driver circuit configured switch on or off a power stage switch according to a duty cycle based on the rectified voltage, to regulate a driving current through the LED string.

As another example, US Patent Application Publication No. 20140103823A1, a LED light source comprises a full bridge rectifier, the LED light source is further equipped with a switchable bleeder current source coupled. between the first and second output terminal of the full bridge rectifier, a latch coupled between the first and second output terminals of the full rectifier bridge and comprising a series arrangement of a resistor and a capacitor to prevent the current through the dimmer from crossing zero after a leading edge generated by the phase cut dimmer, in case the phase cut dimmer is a leading edge phase cut dimmer, a unidirectional element arranged in series with the capacitor for preventing discharging of the capacitor via the LED loads or the adjustable bleeder current source, and a lamp circuit coupled to the capacitor and comprising a current source for discharging the capacitor and providing a low ohmic path for the dimmer current when the dimmer is off.

However, the above prior art examples provide bleeder based solutions for the low intensity operation range in phase cut dimmers. Thus, it would be desirable to provide a solution for dimmer systems based on regulated constant current power supply driving a LED array.

### SUMMARY OF THE INVENTION

Accordingly, it is a principal object of the invention to provide a bleeder based. solution for the low intensity operation range of a dimmable power supply (PS) based LED driver. The disclosed solution relates, in particular, to a dimmable LED lighting arrangement, wherein a LED driver comprises a regulated constant current power supply whose output current cannot go down below a minimum level.

Thus, a control system for a dimmable LED lighting arrangement is disclosed, wherein the LED light is produces by a dimmable LED lamp comprising a regulated constant current power supply (PS). The PS has an output port for providing an output current Iout to a LED array connected thereto, and has a dimming port for receiving a dimming level for adjusting Iout. Iout is adjustable down to a minimum greater than zero denoted as Imin, which is a limitation of the PS. the control system comprises:

a bleeder unit connected to the PS output port in parallel with the LED array and controllable to load the PS by about Imin when activated through an activation port thereof; and

a control circuit operatively coupled to accept a user dimming control level Du, coupled to the PS dimming port for conveying thereto a dimming level which is approximately a linear translation of Du, coupled to said activation port, and configured, when Du corresponds to a desired LED array current I_{L} lower than Imin:

(a) to determine said dimming level so as to adjust Iout as I_{L}+Imin, and

(b) to activate the bleeder unit through said activation port.

In some embodiments, the above bleeder unit is implemented as a resistor. In other embodiments the bleeder unit comprises a constant current source. In some of these embodiments the control system further comprises a current sensing means configured to sense Iout, the control circuit is further operatively coupled to the current sensing means so as to measure Imin based on the sensed Iout, and is further configured to adjust the constant current source according to the measured Imin.

In various embodiments, the dimming level is realized as one of a DC level, a Pulse Width Modulation (PWM) signal and a digital signal.

In accordance with an embodiment of the present invention, there is also provided a method of controlling a dimmable LED lighting arrangement, wherein the LED light is produces by a dimmable LED lamp comprising a regulated constant current power supply (PS) having an output port providing an output current Iout to a LED array connected thereto. Iout is adjustable through a dimming port of the PS down to a minimum greater than zero denoted as Imin. The method comprises the following steps: Providing a bleeder unit connected to the PS output port in parallel with the LED array and controllable to load the PS by about Imin when activated; translating a user dimming control to an appropriate dimming level at the PS dimming port; and when the user dimming control corresponds to a desired LED array current IL lower than Imin:

(a) determining said dimming level so as to adjust Iout as IL+Imin, and

(h) activating the bleeder unit.

### BRIEF DESCRIPTION OF THE DRAWINGS

The present invention. will be more fully understood from the following detailed description of the embodiments thereof, taken together with the drawings in which:

FIG. 1 is a block diagram that schematically illustrates a dimmable LED lighting arrangement, in accordance with an embodiment of the present invention;

FIG. 2 is a graph showing current versus dimming adjustment, in accordance with an embodiment of the present invention; and

FIG. 3 is a flowchart that schematically illustrates a method of controlling a dimmable LED lamp, in accordance with an embodiment of the present invention.

### DETAILED DESCRIPTION OF EMBODIMENTS

Embodiments of the present invention provide dimmable LED lighting systems, wherein a typical lamp comprises a LED string or array driven by a regulated constant current power supply (PS). The techniques disclosed herein allow achieving full dimming (zero light) while using low-cost PSs having minimum output current Imin>0, thereby unable to extinguish the LED light.

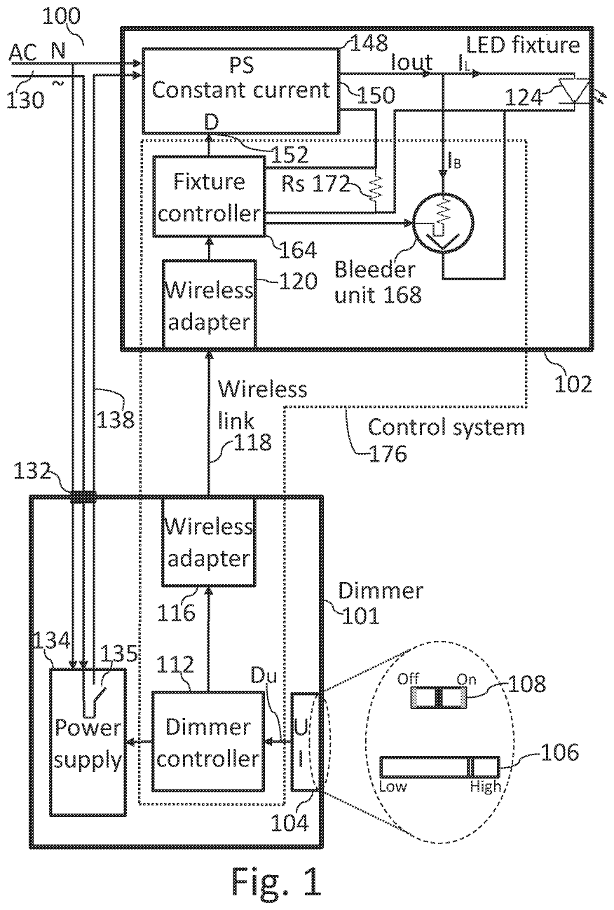

Referring to FIG. 1, there i.s shown a block diagram of a dimmable LED lighting arrangement 100, in accordance with an embodiment of the present invention. In the figure, a dimmer 101 is wireless connected to a LED lamp 102. In typical installations dimmer 101 is wall mounted such that the user can manually operate it, while LED lamp 102 is installed remotely from the user, e.g. it may be ceiling mounted. Dimmer 101 comprises a User interface (UI) 104 comprising a dimming slider 106 which allows a user to continuously adjust the intensity of the light emitted from LED lamp 102. Slider 106 can be implemented as a mechanical slider or by using touch technology. UI 104 also includes an OFF/ON selector 108, that operates through a dimmer controller 112 coupled to UI 104 for switching the AC power of LED lamp 102. Arrangement 100 is powered by an AC line 130. The AC line reaches a power supply 134 in dimmer 101 through an AC port 132. Power supply 134 ON/OFF switches the phase line of AC line 130 by a switch 135, and the switched AC line, indicated by reference numeral 138, continues to LED lamp 102.

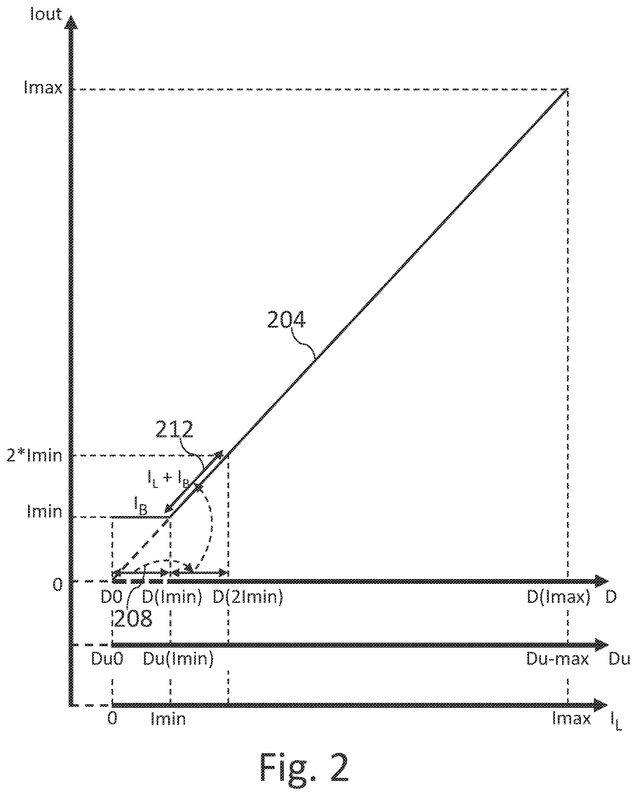

UI 104 outputs a user dimming electric control signal Du, which as proportional to slider 106 state. Controller 112 converts Du level to communication protocol messages that it transfers through a wireless adapter 116 and a wireless link 118 to a wireless adapter 120 in LED lamp 102. LED lamp 102 comprises a LED array 124 powered by a regulated constant current supply (PS) 148 through an output port 150 of the PS. A lamp controller 164 controls the output current of PS 148, denoted as Iout, based on the messages transferred by wireless adapter 120, by a dimming signal D that it transfers to PS 148 through a control port 152. Dimmer controller 112 together with lamp controller 164 constitute a distributed control circuit which is the heart of a control system 176. Control system 176 also comprises a bleeder unit 168 and a current sensing resistor 172 discussed hereinafter. When a user of arrangement 100 shifts slider 106 from its highest position to its lowest position, Du varies from its maximum level to its minimum level respectively. Consequently, control system 176 shall cause the current through LED) array 124, denoted I_{L} to proportionally vary from the maximum level of Iout, denoted as Imax, to zero. This is achieved according to the process shown in FIG. 2 hereinafter.

In one embodiment, each of controllers 112 and 164 comprises a general purpose microcontroller which runs software for carrying out the functions described above. However, any other suitable control means can be used alternatively or additively such as ASICs and FPGAs. The above description has focused on the specific elements of lighting arrangement 100 that are essential for understanding certain features of the disclosed techniques. Conventional elements that are not needed for this understanding have been omitted from FIG. 1 for the sake of simplicity, but will be apparent to persons of ordinary skill in the art. The configuration shown in FIG. 1 is an example configuration, which was chosen purely for the sake of conceptual clarity. In alternative embodiments, any other suitable configurations can also be used.

FIG. 2 is a graph showing currents in control system 176 versus dimming adjustment levels, in accordance with an embodiment of the present invention. The lower horizontal axis I_{L} shows the desired current range through LED array 124. The middle horizontal axis shows the corresponding Du range [Du0, Du-max]. The Du range includes a Du (Imin) point that indicates the user control dimming level corresponding to the minimum PS current Imin. Du (Imin) can be easily calculated as: Du (Imin)=Imin*(Du-max-Du0)/(Imax−Imin)+Du0.

The upper horizontal axis shows the corresponding D range [D0, D(Imax)], which includes a lower virtual D extension [D0, D(Imin)]. This part is an extension of the real D range [D(Imin), D(Imax)]. D0 can be easily calculated as:

D0=−Imin*(D(Imax)−D(Imin))/(Imax−Imin)+D(Imin).

The vertical axis represents lout, which is a linear function 204 of D. The real range of Iout, [Imin, Imax] is achieved by being controller 164 configured to determine D for Du>Du (Imin) as (Du−Du0)*(D(Imax)−D0)/(Du−max−Du0)+D0.

However, as PS 148 output current Iout cannot go below Imin, for Du<Du(Imin), controller 164 is configured to control bleeder unit 168 to load the PS with a current I_{B} approximately equal to Imin, and to determine D as (Un−Du0)*(D(Imax)−D0)/(Du-max−Du0)+D(Imin). This way the virtual D extension [D0, D(Imin)] is displaced to the range [D(Imin), D(2Imin)], which is indicated in FIG. 2 by reference numeral 208. This D displacement causes Iout=desired I_{L}+IB, decreasing from 2Imin to Imin when Du varies from Du(Imin) to Du0, as indicated in FIG. 2 by reference numeral 212. As I_{B}=Imin is subtracted from Iout, the remaining current through LED array 124 decrease then from Imin to 0.

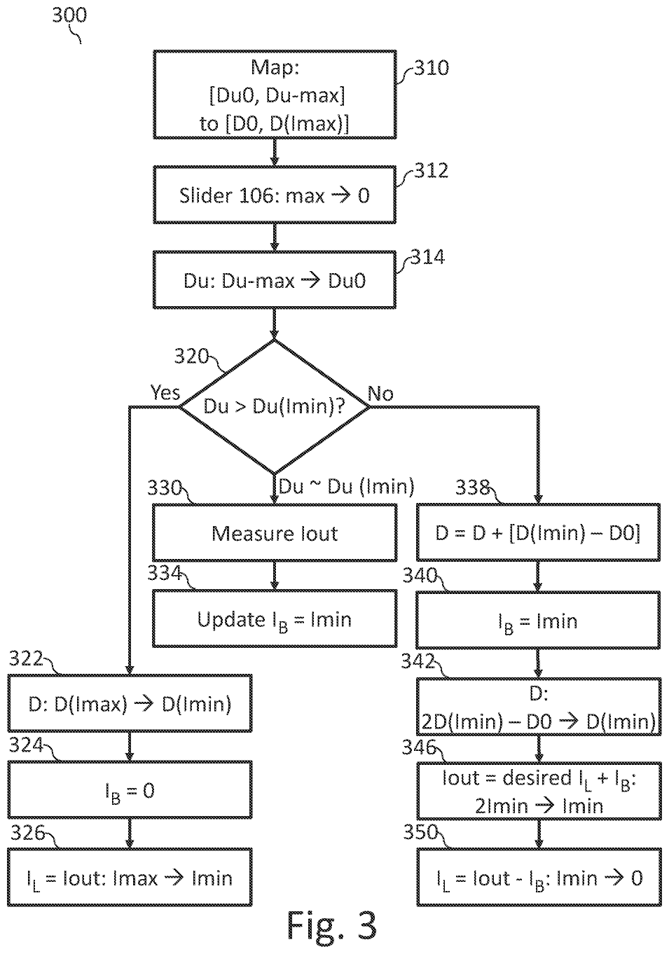

Referring now to FIG. 3, there is shown a flowchart 300 which schematically illustrates a method of controlling dimmable LED lamp 102, in accordance with an embodiment of the present invention. The method begins with a mapping step 310 in which lamp controller 164 maps [Du0, Du-max] to [D0, D(Imax)] as described above. The further method steps are described through tracking the operation of dimmable LED lighting arrangement 100, in particular of control system 176, when a user thereof gradually shifts dimming slider 106 from its highest to lowest position. This shift is illustrated by step 312. The following steps demonstrate how, in typical embodiments, this shift would cause a respective proportional transition of the light emitted from LED array 124 from full light to zero light. In other words, slider 106 shift is approximately linearly converted by control system 176 to a respective gradual intensity variation of LED array 124 light. This is achieved although Iout can only go down to Imin, which is greater than the current that would extinguish LED array 124, i.e. typically close to zero. Step 314 illustrates the respective variation of Du from its maximum to minimum level, which is equal to 0 in typical embodiments, after the conversion of slider 106 position, or state in case of implementation in touch screen, done by UI 104.

Next, in a decision block 320, flowchart 300 splits to three branches depending on the actual value of D. The left branch exiting block 320 relates to Du variation from Du-max to Du0, which causes D to vary from D(Imax) to D(Imin) and Iout to vary from Imax to Imin respectively. This variation is depicted by block 322. As shown in step a 324, lamp controller 164 then commands bleeder unit 168 to cause no loading of PS 148, i.e. I_{B}=0. Consequently I_{L}=Iout, which varies from Imax to Imin, as shown in step 326 that follows.

The middle branch that exits block 320 relates to Du in the vicinity of Du(Imin). As shown in a measuring step 330, lamp controller 164 then measures Iout, by reading the voltage drop on sensing resistor 172. Measuring Iout at the vicinity of Du(Imin), hence D(Imin), while bleeder unit 168 is not active, allows controller 164 to acquire an undated Imin value. In an updating step 334, controller 164 stores the updated Imin value and controls bleeder unit 168 so as to adjust I_{B} according to the updated Imin value. In some embodiments, sensing resistor 172 is not implemented and lamp controller 164 determines Imin only according to a preconfigured Imin value. In the latter cases, bleeder unit 168 is typically implemented as a constant current source. In yet other embodiments neither sensing resistor 172 is implemented nor Imin value is stored in controller 164, and bleeder unit 168 is implemented as a resistor determined so as to load PS 148 with an assumed Imin value when connected thereto.

The right branch exiting block 320 relates to Du<Du0. Lamp controller 164 then steps up D by [Dmin−D0], as explained above with reference to reference numeral 208. This is shown in step 338. Controller 164, in step 340, simultaneously commands bleeder unit 168 to load PS 148 with I_{B}. Step 338 results in the D variation 2D(Imin)−D0→□D(Imin) shown in block 342. Step 338 together with step 340 result in the Iout variation 2Imin→Imin, shown in block 346, which is equal to the desired I_{L}+I_{B}. Finally, step 350 shows a corresponding variation of I_{L} between Imin and about zero, since I_{L}=Iout−I_{B}.

Flowchart 300 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 3 for the sake of simplicity.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A control system for a dimmable LED lighting arrangement, wherein the LED light is produces by a dimmable LED lamp comprising a regulated constant current power supply (PS) having an output port for providing an output current Iout to a LED array connected thereto, and having a dimming port for receiving a dimming level for adjusting Iout, and wherein Iout is adjustable down to a minimum greater than zero denoted as Imin when said dimming level goes down to a minimum, the control system comprising:
a bleeder unit connected t.o the PS output port in parallel with the LED array and controllable to load the PS by drawing Imin thereof when activated through an activation port thereof; and
a control circuit operatively coupled to accept a user dimming control level Du, coupled to the PS dimming port for conveying thereto a dimming level which is a linear translation of Du, coupled to said activation port, and configured, when Du corresponds to a desired LED array current I_{L} lower than Imin:
(a) to determine said dimming level so as to adjust Iout as I_{L}+Imin, and
(b) to activate the bleeder unit through said activation port, thereby to compensate the effect of (a) on I_{L}, thereby to reduce I_{L} to 0 when said dimming level goes down to its minimum while keeping the linear effect of the dimming level the same as in the IL range above Imin.

2. The control system of claim 1, wherein the bleeder unit is configured to load the PS by drawing Imin thereof by means of a resistor.

3. The control system of claim 1, wherein the bleeder unit comprises a constant current source.

4. The control system of claim 3, further comprising a current sensing means configured to sense Iout, and wherein the control circuit is further operatively coupled to the current sensing means so as to measure Imin based on the sensed Iout, and is further configured to adjust the constant current source according to the measured Imin.

5. The control system of claim 1, wherein the dimming level comprises one of a DC level, a Pulse Width Modulation (PWM) signal and a digital signal.

6. A method of controlling a dimmable LED lighting arrangement, wherein the LED light is produces by a dimmable LED lamp comprising a regulated constant current power supply (PS) having an output port for providing an output current Iout to a LED array connected thereto, Iout being adjustable through a dimming port of the PS down to a minimum greater than zero denoted as Imin when said dimming level goes down to a minimum, the method comprising:
providing a bleeder unit connected to the PS output port in parallel with the LED array and controllable to load the PS by drawing Imin thereof when activated;
translating a user dimming control to an appropriate dimming level at the PS dimming port; and
when the user dimming control corresponds to a desired LED array current I_{L} lower than Imin:
(a) determining said dimming level so as to adjust Iout as I_{L}+Imin, and
(b) activating the bleeder unit, thereby to compensate the effect of (a) on I_{L} thereby to reduce I_{L} to 0 when said dimming level goes down to its minimum while keeping the linear effect of the dimming level the same as in the IL range above Imin.

7. The method of claim 6, wherein the bleeder unit is configured to load the PS by drawing Imin thereof by means of a resistor.

8. The method of claim 6, wherein the bleeder unit comprises a constant current source.

9. The method of claim 8, wherein the LED lamp further comprises a current sensing means configured to sense Iout, and the method further comprises the steps of:
measuring Imin based on reading the current sensing means; and
adjusting the constant current source according t.o the measured Imin.

10. The method of claim 6, wherein determining the dimming level is achieved by producing one of a DC level, a Pulse Width Modulation (PWM) signal and a digital signal.
